(19) United States
(12) Patent Application Publication
(10) Pub. No.: US 2025/0157090 A1
(43) Pub. Date: May 15, 2025

(54) DISPLAY CONTROL APPARATUS

(71) Applicant: NTT DOCOMO, INC., Tokyo (JP)

(72) Inventors: Tomohito YAMASAKI, Chiyoda-ku (JP); Susumu SEKINO, Chiyoda-ku (JP)

(73) Assignee: NTT DOCOMO, INC., Tokyo (JP)

(21) Appl. No.: 18/833,490

(22) PCT Filed: Jan. 23, 2023
(86) PCT No.: PCT/JP2023/001883

§ 371 Date: Jul. 26, 2024

(30) Foreign Application Priority Data
Feb. 2, 2022 (JP) 2022-015026

(51) Int. Cl. G06T 11/00; H04L 67/131

(52) U.S. Cl. CPC G06T 11/00; G06T 2200/24; H04L 67/131

(57) ABSTRACT

A display control apparatus includes a destination acquirer configured to acquire at least one destination to which a message is to be transmitted, the at least one destination corresponding to a location in a real space, with the location corresponding to a position in a virtual space at which position a virtual object relating to the message has been placed, based on location information indicative of the location in the real space, and correspondence information indicative of a correspondence between the location in the real space and the at least one destination, to which the message is to be transmitted; and a display controller configured to cause a display device to display the virtual space including both the virtual object and a destination image representative of the at least one destination.

### TECHNICAL FIELD

The present invention relates to a display control apparatus. In particular, the present invention relates to a display control apparatus that displays a virtual object related to a message in a virtual space.

### BACKGROUND ART

A message represented by a virtual object is sometimes displayed in a virtual space displayed on XR glasses worn on a user's head, with use of XR technologies including a VR (Virtual Reality) technology, an AR (Augmented Reality) technology, and an MR (Mixed Reality) technology.

For example, Patent Document 1 discloses a technology of sharing a message in a virtual space in order to establish communication among users. Specifically, Patent Document 1 discloses a technology of displaying a virtual object representing a “graffiti message” in a virtual space shared by users. This “graffiti message” can be viewed by any user who can access the virtual space.

### RELATED ART DOCUMENT

### Patent Document

Patent Document 1: Japanese Translation of PCT International Application Publication No. JP-T-2010-535363

### SUMMARY OF THE INVENTION

### Problems to be Solved by the Invention

However, since the conventional technologies enable a virtual object representing a message to be shared among users who can access a virtual space, there is no specific destination of the message. Therefore, in conventional technologies, the destination of a message with a destination cannot be confirmed in a virtual space. When a user intends to specify a destination to transmit a message in a virtual space, it is difficult to input the destination because there is no physical keyboard in the virtual space. For example, in a case in which a virtual keyboard is displayed in a virtual space is assumed, the user needs to click keys provided on the virtual keyboard one by one to input the destination.

In view of these circumstances, an object of the present invention is to provide a display control apparatus that enables a user to easily designate and confirm a destination of a message when transmitting the message to another user in a virtual space.

### Means for Solving the Problems

A display control apparatus according to a preferred aspect of the present invention is a display control apparatus including: a destination extractor configured to extract (a destination acquirer configured to acquire) at least one destination to which a message is to be transmitted, the at least one destination corresponding to a location in a real space, with the location corresponding to a position in a virtual space at which position a virtual object relating to the message has been placed, based on location information indicative of the location in the real space, and correspondence information indicative of a correspondence between the location in the real space and the at least one destination, to which the message is to be transmitted; and a display controller configured to cause a display device to display the virtual space including both the virtual object and a destination image representative of the at least one destination.

### Effect of the Invention

According to the present invention, when a user transmits a message to another user in a virtual space, it is possible to easily designate and confirm a destination of the message.

### BRIEF DESCRIPTION OF THE DRAWINGS

FIG. 1 is a diagram illustrating an overall configuration of an information processing system 1 according to a first embodiment.

FIG. 2 is a perspective view illustrating an appearance of XR glasses 20 according to the first embodiment.

FIG. 3 is a schematic diagram of a composite space MS in which a virtual space VS is superimposed on a real space RS and which is provided to a user Uₖ when the XR glasses 20 according to the first embodiment are used.

FIG. 4 is a block diagram illustrating a configuration example of the XR glasses 20 according to the first embodiment.

FIG. 5 is a block diagram illustrating a configuration example of a terminal apparatus 10-K according to the first embodiment.

FIG. 6 is a configuration example of a correspondence database CD.

FIG. 7 is a functional block diagram of an acquirer 111.

FIG. 8 is a functional block diagram of a generator 112.

FIG. 9 is an explanatory diagram illustrating an example operation of the generator 112, a destination acquirer 113, a display controller 114, a receiver 115, and a communication controller 116.

FIG. 10 is an explanatory diagram illustrating an example operation of the generator 112, the destination acquirer 113, the display controller 114, the receiver 115, and the communication controller 116.

FIG. 11 is an explanatory diagram illustrating an example operation of the generator 112, the destination acquirer 113, the display controller 114, the receiver 115, and the communication controller 116.

FIG. 12 is a block diagram illustrating a configuration example of a server 30.

FIG. 13 is a flowchart illustrating an operation of the terminal apparatus 10-K according to the first embodiment.

FIG. 14 is a functional block diagram of an acquirer 111C.

FIG. 15 is a functional block diagram of a generator 112C.

### MODES FOR CARRYING OUT THE INVENTION

### 1. First Embodiment

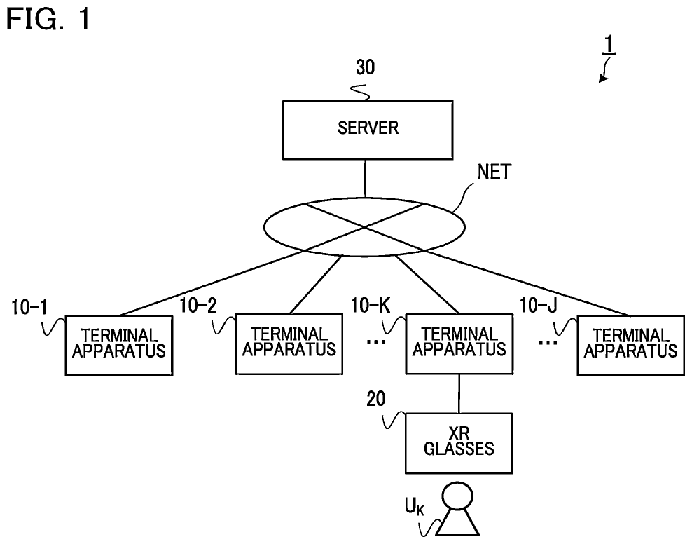

An information processing system 1 including a terminal apparatus 10-K as a display control apparatus according to a first embodiment of the present invention is described below with reference to FIGS. 1 to 13.

### 1-1: Configuration of First Embodiment

### 1-1-1: Overall Configuration

FIG. 1 illustrates an overall configuration of the information processing system 1. As illustrated in FIG. 1, the information processing system 1 includes terminal apparatuses 10-1, 10-2, . . . , 10-K, . . . , and 10-J, a pair of XR glasses 20, and a server 30. J is an integer equal to or greater than 1. K is an integer not less than 1 and not greater than J. In the present embodiment, while the terminal apparatuses 10-1, 10-2, . . . , 10-K, . . . , and 10-J have the same configuration, a terminal apparatus having a configuration different from that of other terminal apparatuses may be included.

In the information processing system 1, the terminal apparatus 10-K and the server 30 are communicably connected to each other via a communication network NET. The terminal apparatus 10-K and the XR glasses 20 are also communicably connected to each other. In FIG. 1, it is assumed that a user Uₖ uses a pair of the terminal apparatus 10-K and the XR glasses 20. The terminal apparatus 10-K is an example of the display control apparatus.

The server 30 provides various types of data and cloud services to the terminal apparatus 10-K via the communication network NET.

The terminal apparatus 10-K causes the XR glasses 20 worn on the head of the user Uₖ to display a virtual object arranged in a virtual space. The virtual space is a spherical space, for example. Examples of the virtual object include a virtual object representing data such as a still image, a moving image, a 3DCG model, an HTML file, and a text file, and a virtual object representing an application. Examples of the text file include a memorandum, a source code, a diary, and a recipe. Examples of the application include a browser, an application for using an SNS, and an application for creating a document file. The terminal apparatus 10-K is preferably a mobile terminal apparatus such as a smartphone and a tablet, for example.

The XR glasses 20 are a see-through wearable display to be worn on the head of the user Uₖ. The XR glasses 20 cause a display panel provided on each of binocular lenses to display a virtual object under control of the terminal apparatus 10-K. The XR glasses 20 comprise an example of a display device. In the following descriptions, a mode in which the XR glasses 20 are MR glasses is explained. However, this is merely an example, and the XR glasses 20 may be VR glasses or AR glasses.

In particular, in the present embodiment, the user Uₖ wearing the XR glasses 20 on the user's head uses the terminal apparatus 10-K to transmit a message to a terminal apparatus 10-M used by another user U_{M}. As will be specifically described later, the user Uₖ transmits a message to the user U_{M} by placing a virtual object relating to the message in a virtual space and designating a destination of the user U_{M}. In the descriptions, M is an integer not less than 1 and not greater than J, and other than K.

### 1-1-2: Configuration of XR Glasses

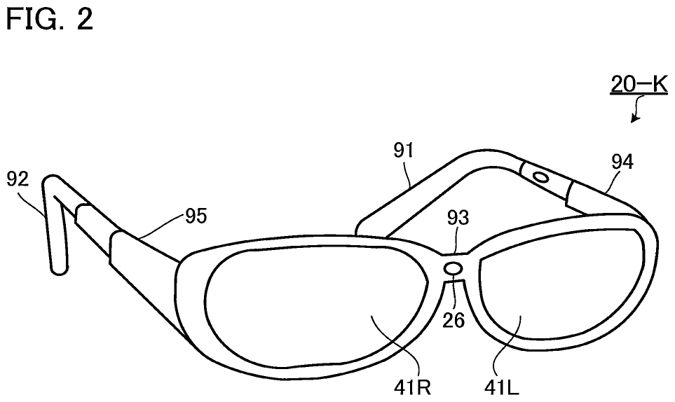

FIG. 2 is a perspective view illustrating an appearance of the XR glasses 20. As illustrated in FIG. 2, in the appearance, the XR glasses 20 include temples 91 and 92, a bridge 93, frames 94 and 95, and lenses 41L and 41R similarly to normal glasses.

An image capture device 26 is provided on the bridge 93. The image capture device 26 captures images of a real world. The image capture device 26 outputs captured image information representing the captured images.

Each of the lenses 41L and 41R includes a half mirror. A left-eye liquid-crystal panel or organic EL panel is provided on the frame 94. A liquid-crystal panel or an organic EL panel is hereinafter generally called a “display panel”. An optical member that guides light emitted from the left-eye display panel to the lens 41L is provided on the frame 94. The half mirror provided on the lens 41L transmits light in the real world to guide the light to the left eye, and also reflects the light guided by the optical member and then causes the reflected light to be incident on the left eye. A right-eye display panel and an optical member that guides light emitted from the right-eye display panel to the lens 41R are provided on the frame 95. The half mirror provided on the lens 41R transmits light of the real world to guide the light to the right eye, and also reflects the light guided by the optical member and then causes the reflected light to be incident on the right eye.

A display 28 described later includes the lens 41L, the left-eye display panel, the left-eye optical member, the lens 41R, the right-eye display panel, and the right-eye optical member.

In the configuration described above, the user Uₖ can observe an image displayed on the display panels in a see-through manner where the image is superimposed on the real-world view. The XR glasses 20 cause the left-eye display panel to display an image for the left eye of binocular images with parallax and cause the right-eye display panel to display an image for the right eye. Accordingly, the XR glasses 20 cause the user Uₖ to perceive the displayed image as if it has depth and is three dimensional.

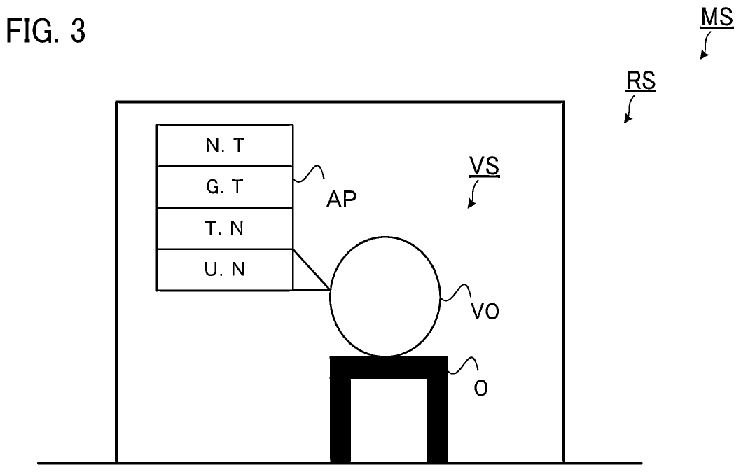

FIG. 3 is an example of a schematic diagram illustrating a composite space MS in which a virtual space VS is superimposed on a real space RS. The composite space MS is provided to the user Uₖ when the XR glasses 20 are used in the present embodiment. It is assumed that an object O has been placed in the real space RS. In the composite space MS, the user Uₖ places on the object O a virtual object VO relating to a message to be transmitted to another user U_{M}. When the user Uₖ places the virtual object VO, a destination image AP indicative of a list of destinations highly relevant to the location in the real space RS where the object O has been placed is displayed in the virtual space VS included in the composite space MS. The user Uₖ selects the destination of the user U_{M} as a message destination from the destinations indicated by the destination image AP. When the user Uₖ selects the user U_{M} as a person to which the message is to be transmitted, the message is transmitted to the user U_{M}.

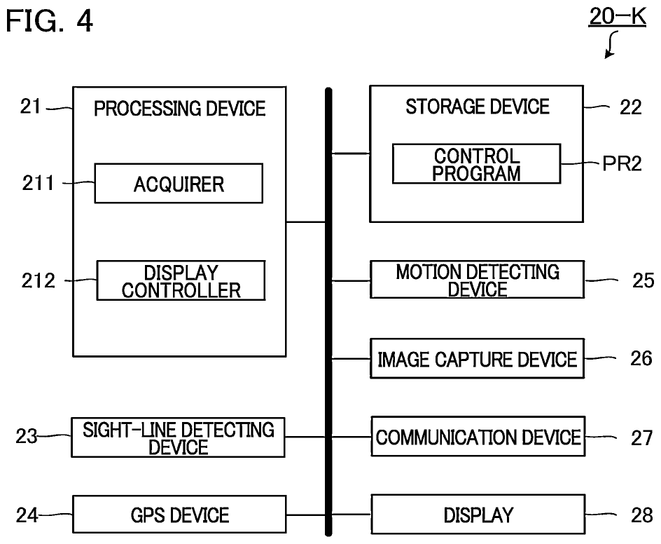

FIG. 4 is a block diagram illustrating a configuration example of the XR glasses 20. The XR glasses 20 include a processing device 21, a storage device 22, a line-of-sight detecting device 23, a GPS device 24, a motion detecting device 25, the image capture device 26, a communication device 27, and the display 28. These elements included in the XR glasses 20 are connected to one another with a single bus or a plurality of buses for communicating information. The term “device” in the present specification may be called by other terms such as circuit, or unit.

The processing device 21 is a processor that controls the entire XR glasses 20. For example, the processing device 21 is configured using a single chip or a plurality of chips. For example, the processing device 21 is configured using a CPU (Central Processing Unit) including an interface with peripheral devices, an arithmetic device, a register, and the like. Some or all of functions of the processing device 21 may be realized by hardware such as a DSP (Digital Signal Processor), an ASIC (Application Specific Integrated Circuit), a PLD (Programmable Logic Device), and an FPGA (Field Programmable Gate Array). The processing device 21 performs various types of processing in a parallel or serial manner.

The storage device 22 is a recording medium that is readable and writable by the processing device 21. The storage device 22 stores therein programs including a control program PR2 to be executed by the processing device 21.

The line-of-sight detecting device 23 detects a line-of-sight of the user Uₖ and subsequently generates line-of-sight information representing the detection result. The line-of-sight detecting device 23 can employ any method to detect a line-of-sight. For example, the line-of-sight detecting device 23 may detect line-of-sight information on the basis of the position of the inner corner of one eye and the position of the iris thereof. The line-of-sight information represents the direction of the line-of-sight of the user Uₖ. The line-of-sight detecting device 23 supplies the line-of-sight information to the processing device 21 described later. The line-of-sight information supplied to the processing device 21 is transmitted to the terminal apparatus 10-K via the communication device 27.

The GPS device 24 receives radio waves from satellites. The GPS device 24 generates position information from the received radio waves. The position information represents a position of the XR glasses 20. The position information may have any form as long as the position can be specified. For example, the position information represents a latitude and longitude of the XR glasses 20. As an example, the position information can be acquired from the GPS device 24. However, the XR glasses 20 may acquire the position information by any method. The acquired position information is supplied to the processing device 21. The position information supplied to the processing device 21 is transmitted to the terminal apparatus 10-K via the communication device 27.

The motion detecting device 25 detects motions of the XR glasses 20. An inertia sensor such as an acceleration sensor that detects an acceleration or a gyroscope sensor that senses an angular acceleration corresponds to the motion detecting device 25. The acceleration sensor senses accelerations on an X-axis, a Y-axis, and a Z-axis that are orthogonal to one another. The gyroscope sensor senses angular accelerations around the X-axis, the Y-axis, and the Z-axis as central axes of rotation. The motion detecting device 25 can generate attitude information representing an attitude of the XR glasses 20 on the basis of output information from the gyroscope sensor. Motion information includes pieces of acceleration data each representing an acceleration of one of the three axes, and pieces of angular acceleration data each representing an angular acceleration of one of the three axes. The motion detecting device 25 supplies attitude information representing the attitude of the XR glasses 20 and motion information related to motions of the XR glasses 20 to the processing device 21. The attitude information and motion information supplied to the processing device 21 are transmitted to the terminal apparatus 10-K via the communication device 27.

The image capture device 26 outputs captured image information acquired by capturing an image of the real world view. The image capture device 26 includes, for example, a lens, an imaging element, an amplifier, and an AD converter. Light collected via the lens is converted by the imaging element into an imaging signal as an analog signal. The amplifier amplifies the imaging signal and outputs the resultant signal to the AD converter. The AD converter converts the amplified imaging signal as an analog signal into captured image information, which is a digital signal. The converted captured image information is supplied to the processing device 21. The captured image information supplied to the processing device 21 is transmitted to the terminal apparatus 10-K via the communication device 27.

The communication device 27 is a piece of hardware in the form of a transmission and reception device for performing communication with other devices. The communication device 27 is also referred to as, for example, a network device, network controller, network card, or communication module. The communication device 27 may include a connector for wired connection and an interface circuit associated with to the connector. The communication device 27 may also include a wireless communication interface. Products complying with a wired LAN, IEEE 1394, or USB are cited as the connector for wired connection and the interface circuit. Products complying with a wireless LAN, Bluetooth (Registered Trademark), or the like are cited as the wireless communication interface.

The display 28 is a device that displays images. The display 28 displays various types of images under the control of the processing device 21. As described above, the display 28 includes the lens 41L, the left-eye display panel, the left-eye optical member, the lens 41R, the right-eye display panel, and the right-eye optical member. For example, various types of display panels such as liquid-crystal display panels and organic EL display panels are preferably used as the display panels.

The processing device 21 functions as, for example, an acquirer 211 and a display controller 212 by reading the control program PR2 from the storage device 22 and executing the program.

The acquirer 211 acquires image information representing an image to be displayed on the XR glasses 20 from the terminal apparatus 10-K.

The acquirer 211 acquires the line-of-sight information supplied from the line-of-sight detecting device 23, the position information supplied from the GPS device 24, the motion information supplied from the motion detecting device 25, and the captured image information supplied from the image capture device 26. Upon acquisition, the acquirer 211 supplies the acquired line-of-sight information, position information, motion information, and captured image information to the communication device 27.

On the basis of the image information acquired from the terminal apparatuses 10 by the acquirer 211, the display controller 212 causes the display 28 to display an image represented by the image information.

### 1-1-3: Configuration of Terminal Apparatus

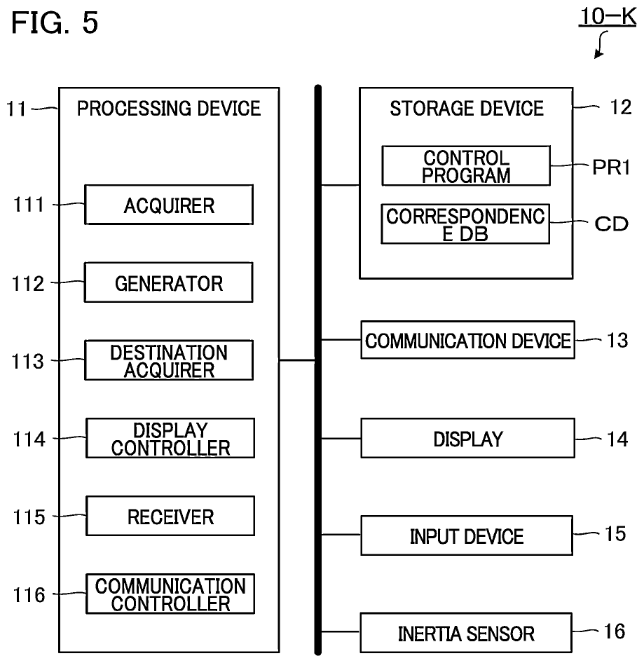

FIG. 5 is a block diagram illustrating a configuration example of the terminal apparatus 10-K. The terminal apparatus 10-K includes a processing device 11, a storage device 12, a communication device 13, a display 14, an input device 15, and an inertia sensor 16. These elements included in the terminal apparatus 10-K are connected to one another with a single bus or a plurality of buses for communicating information.

The processing device 11 is a processor that controls the entire terminal apparatus 10-K. For example, the processing device 11 is configured using a single chip or a plurality of chips. For example, the processing device 11 is configured using a central processing unit (CPU) including an interface with peripheral devices, an arithmetic device, a register, and the like. Some or all of functions of the processing device 11 may be realized by hardware such as a DSP, an ASIC, a PLD, and an FPGA. The processing device 11 performs various types of processing in a parallel or serial manner.

The storage device 12 is a recording medium that is readable and writable by the processing device 11. The storage device 12 stores therein programs including a control program PR1 to be executed by the processing device 11. The storage device 12 may also store therein image information representing images to be displayed on the XR glasses 20.

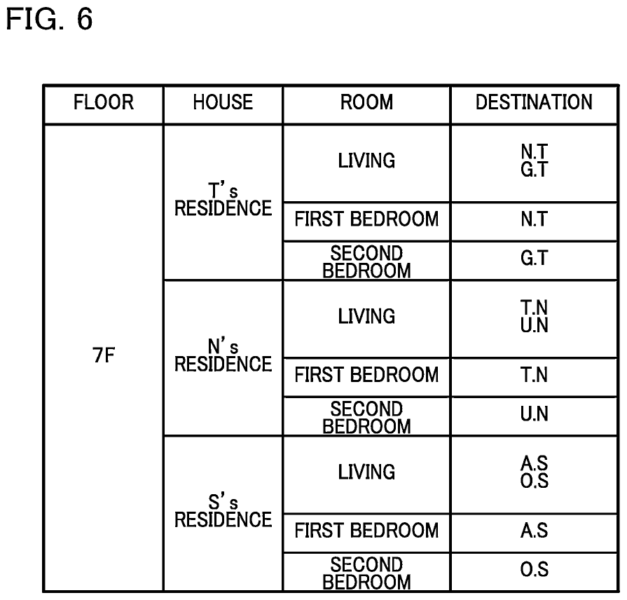

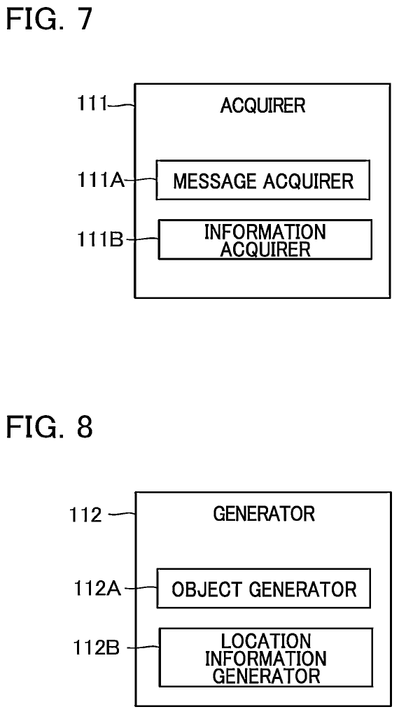

The storage device 12 also stores therein a correspondence database CD. FIG. 6 illustrates a configuration example of the correspondence database CD. The correspondence database CD exemplified in FIG. 6 corresponds to one floor of a collective housing building. Correspondences between location information representing a location in a real space RS and at least one destination are stored in the correspondence database CD illustrated in FIG. 6. The location information has an information structure divided into layers according to area sizes. In FIG. 6, the structure included in the location information stored in the correspondence database CD has a layer corresponding to “floor” as a layer corresponding to a location having the largest area size. Specifically, the location information includes the floor “7F” of the collective housing building as a location in the layer corresponding to a location having the largest area size. In FIG. 7, the structure included in the location information stored in the correspondence database CD has a layer corresponding to “house” as a layer corresponding to a location having the second largest area size. Specifically, the location information includes “T's residence”, “N's residence”, and “S's residence” included in “7F” of the collective housing building as locations of the layer corresponding to a location having the second largest area size. Also in FIG. 7, the structure included in the location information stored in the correspondence database CD has a layer corresponding to “room” as a layer corresponding to a location having the third largest area size. Specifically, as an example, the location information includes “living room”, “first bedroom”, and “second bedroom” included in “T's residence” described above as locations of the layer corresponding to a location having the third largest area size.

A correspondence between each location in the layer that corresponds to a location having the smallest area size in the structure included in location information, and at least one destination is stored in the correspondence database CD. The “at least one destination” is an individual or a corporation that is highly relevant to the “location having the smallest area size”. In addition, “being highly relevant” indicates, as an example, that the frequency of using the “location having the smallest area size” is higher than a predetermined value. In the example illustrated in FIG. 7, for “living room” in “T's residence” on “7F”, a person “N.T” and a person “G.T” as individuals that are highly relevant to the “living room” are defined as destinations. In the example illustrated in FIG. 7, persons identified by the same initials are assumed to be the same person. For example, the person “N.T” corresponding to “living room” in “T's residence” on “7F” and the person “N.T” corresponding to “first bedroom” in “T's residence” on “7F” are assumed to be the same person. The “destination” in “at least one destination” is not limited to a destination of an individual and may be a destination of a corporation. The user Uₖ may input the correspondence database CD to the terminal apparatus 10-K using the input device 15 described later. Alternatively, an acquirer 111 described later may acquire the correspondence database CD from an external device via the communication device 13.

Referring back to FIG. 5, the communication device 13 is hardware in the form of a transmission and reception device for performing communication with other devices. The communication device 13 is also referred to as, for example, a network device, network controller, network card, or communication module. The communication device 13 may include a connector for wired connection and an interface circuit associated with the connector. The communication device 13 may also include a wireless communication interface. Products complying with a wired LAN, IEEE 1394, or USB are cited as the connector for wired connection and the interface circuit. Products complying with a wireless LAN, Bluetooth (Registered Trademark), or the like are cited as the wireless communication interface.

The display 14 is a device that displays images and text information. The display 14 displays various types of images under control of the processing device 11. For example, various types of display panels such as a liquid-crystal display panel and an organic EL (Electro Luminescence) display panel are preferably used as the display 14. The input device 15 receives user operations by the user Uₖ wearing the XR glasses 20 on the head. For example, the input device 15 is configured to include a keyboard, a touch pad, a touchscreen, or a pointing device such as a mouse. In a case in which the input device 15 is configured to include a touchscreen, the input device 15 may also function as the display 14.

The inertia sensor 16 is a sensor that senses inertial force. The inertia sensor 16 includes one or more sensors among, for example, an acceleration sensor, an angular velocity sensor, and a gyroscope sensor. The processing device 11 senses the attitude of the terminal apparatus 10-K on the basis of output information from the inertia sensor 16. The processing device 11 receives selection of a virtual object VO, input of text, and input of an instruction in the virtual space VS on the basis of the attitude of the terminal apparatus 10-K. For example, when the user Uₖ operates the input device 15 in a state in which the central axis of the terminal apparatus 10-K is directed to a predetermined region in a virtual space VS, a virtual object VO arranged in the predetermined region is selected. The user operation performed by the user Uₖ on the input device 15 is a double tap, for example. With this user operation on the terminal apparatus 10-K, the user Uₖ can select the virtual object VO without looking at the input device 15 of the terminal apparatus 10-K.

The processing device 11 reads the control program PR1 from the storage device 12 and executes the program. As a result, the processing device 11 functions as the acquirer 111, a generator 112, a destination acquirer 113, a display controller 114, a receiver 115, and a communication controller 116.

FIG. 7 is a functional block diagram of the acquirer 111. The acquirer 111 includes a message acquirer 111A and an information acquirer 111B.

The message acquirer 111A acquires a message generated by the user Uₖ. The message may be, for example, a message input by the user Uₖ to the terminal apparatus 10-K using the input device 15. Alternatively, the message may be a message acquired by the processing device 11 from an external device via the communication device 13. A destination is set in the message at a time point before the message is transmitted to another user U_{M} by a method described later. However, no destination is set in the message at a time point when the message is acquired by the message acquirer 111A.

The information acquirer 111B acquires designation information in which a layer corresponding to the area size of a location is designated by the user Uₖ. For example, referring to the correspondence database CD illustrated in FIG. 6, the user Uₖ inputs designation information designating “floor”, “house”, or “room” as a relevant “layer” of a location in the information structure included in the location information, in which locations are classified into layers according to the area sizes. The information acquirer 111B acquires the designation information input by the user Uₖ. The information acquirer 111B may acquire designation information input by the user Uₖ using the input device 15 or may acquire designation information from an external device via the communication device 13. Alternatively, in a case in which the display controller 114, described later, displays a layer image showing a list of layers in the virtual space VS, the information acquirer 111B may acquire designation information on the basis of an operation performed by the user Uₖ with respect to the layer image and received by the receiver 115 described later.

FIG. 8 is a functional block diagram of the generator 112. The generator 112 includes an object generator 112A and a location information generator 112B.

The object generator 112A generates a virtual object VO relating to a message acquired by the message acquirer 111A. The object generator 112A may generate the virtual object VO using the image information that is stored in the storage device 12 and that represents an image to be displayed on the XR glasses 20. Alternatively, the object generator 112A may generate the virtual object VO using image information that is acquired from the server 30 via the communication device 13 and that represents an image to be displayed on the XR glasses 20.

The location information generator 112B generates, based on position information representing a position in a virtual space VS at which position the user Uₖ has placed the virtual object VO generated by the object generator 112A and the designation information acquired by the information acquirer 111B, location information representing a location in a real space RS, with the location corresponding to a position in the virtual space VS. For example, when an X-axis, a Y-axis, and a Z-axis that are orthogonal to one another are assumed in the virtual space VS, the position information representing a position in the virtual space VS at which position the user Uₖ has placed the virtual object VO is represented by coordinates on these three axes. The location information generator 112B generates, based on this position information and designation information representing a layer corresponding to the area size of a location designated by the user Uₖ, location information representing a location in the real space RS corresponding to the position in the virtual space VS at which position the virtual object VO has been placed. With reference to the example illustrated in FIG. 6, in a case in which the position in the virtual space VS represented by the position information corresponds to a point in a “living room” in “T's residence” on “7F” in the real space RS and in which the layer represented by the designation information is a “floor”, the location information generator 112B generates location information representing “7F”. In a case in which the position in the virtual space VS represented by the position information corresponds to a point in “first bedroom” in “N's residence” on “7F” in the real space RS and in which the layer represented by the designation information is a “house”, the location information generator 112B generates location information representing “N's residence” on “7F”. In a case in which the position in the virtual space VS represented by the position information corresponds to a point in a “second bedroom” in “S's residence” on “7F” in the real space RS and in which the layer represented by the designation information is a “room”, the location information generator 112B generates location information representing “second bedroom” in “S's residence” on “7F”

Referring back to FIG. 5, the destination acquirer 113 acquires at least one destination corresponding to a location where the virtual object VO has been placed, based on correspondence information representing a correspondence between location information generated by the location information generator 112B and at least one destination that is the location in the real space RS and to which the message is to be transmitted. For example, with reference to FIG. 6, in a case in which the location information represents “second bedroom” in “S's residence” on “7F”, the destination acquirer 113 acquires a person “O.S” as a destination corresponding to the location where the virtual object VO has been placed. For example, in a case in which the location information represents “T's residence”, the destination acquirer 113 acquires a person “N.T” and a person “G.T” both corresponding to a “living room” included in “T's residence”, the person “N.T” corresponding to “first bedroom” included in “T's residence”, and the person “G.T” corresponding to “second bedroom” included in “T's residence”. However, the person “N.T” corresponding to a “living room” and the person “N.T” corresponding to “first bedroom” are the same person. Accordingly, when the location information represents “T's residence”, the destination acquirer 113 extracts the person “N.T” only once. Similarly, the person “G.T” corresponding to a “living room” and the person “G.T” corresponding to “second bedroom” are the same person. Accordingly, when the location information represents “T's residence”, the destination acquirer 113 acquires the person “G.T” only once. That is, when the location information represents “T's residence”, the destination acquirer 113 acquires two persons that are the person “N.T” and the person “G.T”.

Referring back to FIG. 5, the display controller 114 causes the XR glasses 20 as a display device to display a virtual space VS including the virtual object VO generated by the object generator 112A and a destination image AP indicative of at least one destination acquired by the destination acquirer 113.

As a result, when the user Uₖ transmits a message to another user U_{M} in the virtual space VS, the user Uₖ can easily designate and confirm the destination. In particular, the user Uₖ can easily recognize at least one destination that is highly relevant to the location in the real space RS corresponding to the position in the virtual space VS at which position the virtual object VO has been placed.

The display controller 114 may cause the XR glasses 20 as a display device to display a virtual space VS including the virtual object VO and the layer image showing a list of layers at a stage before the display controller 114 causes the XR glasses 20 to display the virtual space VS including the virtual object VO and the destination image AP.

The receiver 115 receives a user operation by the user Uₖ made to the destination image AP. When the display controller 114 causes the XR glasses 20 to display a virtual space VS including a layer image, the receiver 115 receives a user operation by the user Uₖ made to the layer image.

The communication controller 116 transmits the message described above to a destination included in the at least one destination described above in accordance with the user operation by the user Uₖ received by the receiver 115.

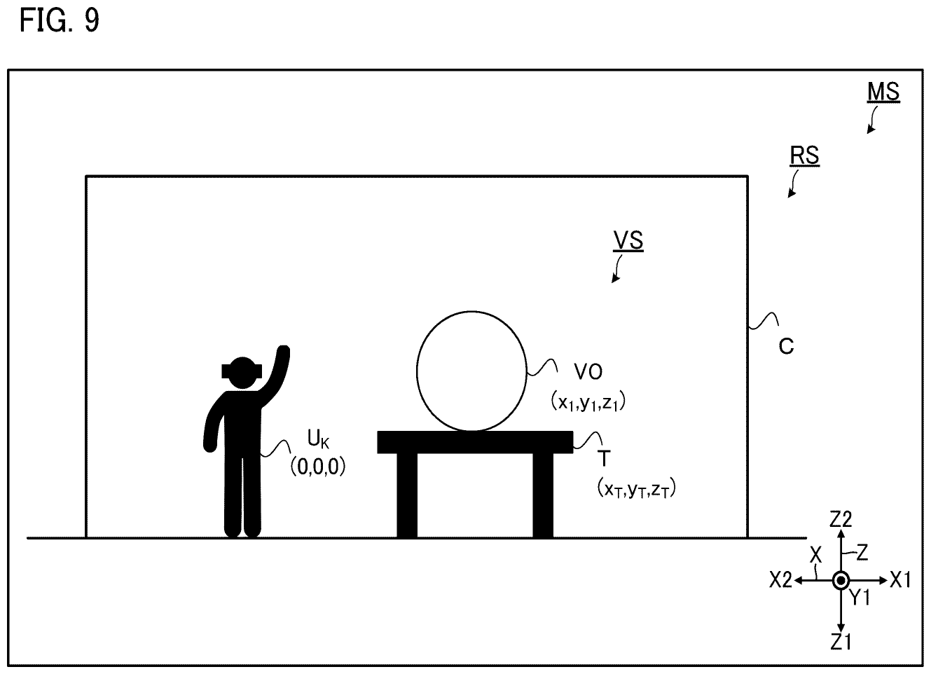

FIGS. 9 to 11 are explanatory diagrams illustrating example operations of the generator 112, the destination acquirer 113, the display controller 114, the receiver 115, and the communication controller 116. In FIG. 9, it is assumed that a real space RS and a virtual space VS are superimposed one on the other to constitute a composite space MS. It is assumed that there is a room C in the real space RS, with a table T arranged therein.

In the virtual space VS, an X-axis, a Y-axis, and a Z-axis that are orthogonal to one another are assumed. As an example, the X-axis extends in the forward and backward directions of the user Uₖ. As viewed from the user Uₖ, the forward direction along the X-axis is an X1 direction and the backward direction along the X-axis is an X2 direction. The Y-axis extends in the rightward and leftward directions of the user Uₖ. As viewed from the user Uₖ, the rightward direction along the Y-axis is a Y1 direction and the leftward direction along the Y-axis is a Y2 direction. The X-axis and the Y-axis constitute a horizontal plane. The Z-axis is orthogonal to the XY plane and extends in the upward and downward directions of the user Uₖ. As viewed from the user Uₖ, the downward direction along the Z-axis is a Z1 direction and the upward direction along the Z-axis is a Z2 direction. The X-axis, the Y-axis, and the Z-axis are applicable not only to the virtual space VS but also to the composite space MS. In FIG. 9, the user Uₖ is assumed to be positioned at (x, y, z)=(0, 0, 0). In the room C, it is assumed that the coordinates of the central position of the top of the table T in the composite space MS in the X-axis direction, the Y-axis direction, and the Z-axis direction are (x, y, z)=(XT, YT, ZT).

As an example, it is assumed here that the user Uₖ has created a message using the input device 15 provided in the terminal apparatus 10-K. The message acquirer 111A provided in the acquirer 111 acquires this message.

The object generator 112A generates a virtual object VO relating to the message acquired by the message acquirer 111A. The display controller 114 displays the virtual object VO in the virtual space VS. In the example illustrated in FIG. 9, the virtual object VO is assumed to be spherical. However, the form of the virtual object VO is not limited to being spherical. For example, the virtual object VO may be cuboid or sheet shaped.

It is assumed that the user Uₖ places the virtual object VO on the top of the table T in the composite space MS. More specifically, it is assumed that the user Uₖ places the virtual object VO at a position at which the coordinates of the center of this virtual object VO are (x, y, z)=(x₁, y₁, z₁).

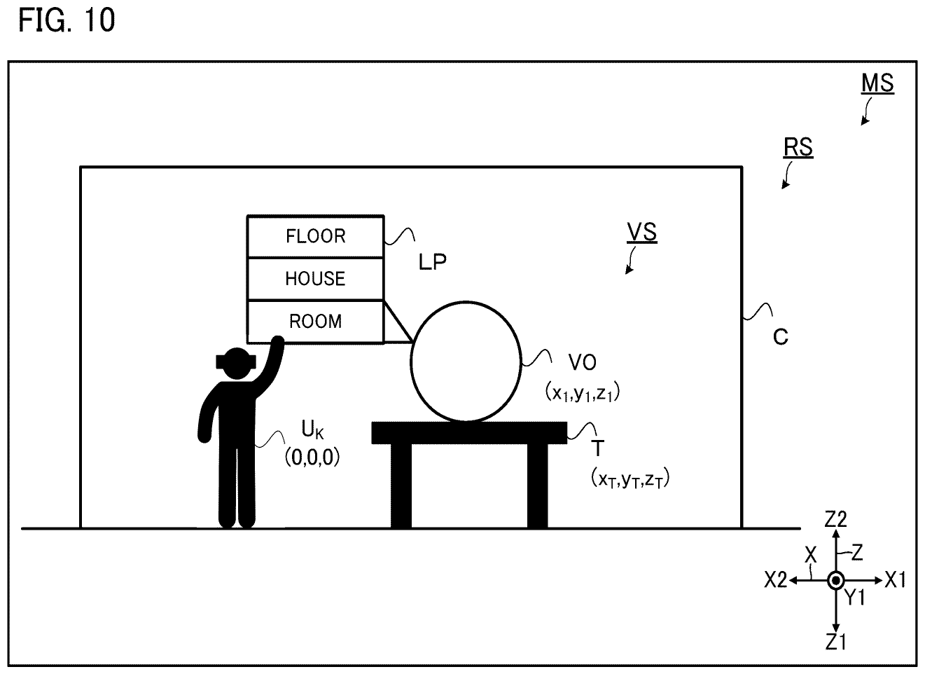

In response, as illustrated in FIG. 10, the display controller 114 causes the XR glasses 20 to display a virtual space VS including the virtual object VO and a layer image LP showing a total of three layers that are a “floor”, “house”, and “room” as a list of layers. It is assumed here that the user Uₖ performs a double tap on “floor” in the layers shown in the layer image LP. The receiver 115 receives the double tap by the user Uₖ on the layer representing “floor” as a user operation by the user Uₖ made to the layer image LP. The information acquirer 111B provided in the acquirer 111 acquires designation information designating “floor” as a layer corresponding to the area size of the location. That is, in the example illustrated in FIG. 10, the information acquirer 111B acquires the designation information after the user Uₖ has placed the virtual object VO in the virtual space VS. As a result, after placing the virtual object VO in the virtual space VS, the user Uₖ can designate the unit of scale to be used as the unit of the location in the real space RS including the position at which the virtual object VO has been placed.

The location information generator 112B generates location information on the basis of position information representing the position of the virtual object VO in the virtual space VS, i.e., where the coordinates of the center of the virtual object VO are (x, y, z)=(x₁, y₁, z₁), and the designation information designated by the user Uₖ. For example, in a case in which the coordinates (x, y, z)=(x₁, y₁, z₁) of the center of the virtual object VO indicate a position in a “living room” in “N's residence” on “7F” in the correspondence database CD exemplified in FIG. 6 and in which the designation information designated by the user Uₖ is “floor”, the location information generator 112B generates location information “7F”. As a result, in order for the user Uₖ to recognize at least one destination that is highly relevant to the location in the real space RS corresponding to the position in the virtual space VS at which position the virtual object VO has been placed, the user Uₖ can designate “7F” in the unit of “floor” as the location in the real space RS.

The destination acquirer 113 acquires at least one destination corresponding to the location where the virtual object VO has been placed based on the location information “7F” and correspondence information included in the correspondence database CD. Specifically, in the correspondence database CD exemplified in FIG. 6, destinations corresponding to “7F” are six persons: the person “N.T”, the person “G.T”, a person “T.N”, a person “U.N”, a person “A.S”, and the person “O.S”. The destination acquirer 113 acquires destinations of these six persons.

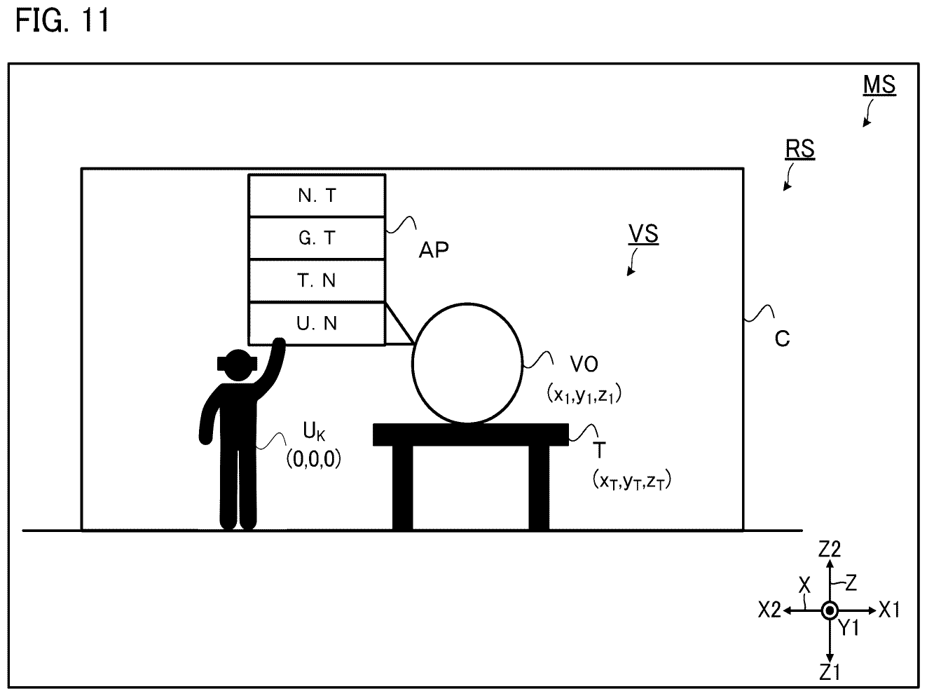

Subsequently, as illustrated in FIG. 11, the display controller 114 causes the XR glasses 20 to display a virtual space VS including the virtual object VO and a destination image AP indicative of the destinations of a total of six persons: the person “N.T”, the person “G.T”, the person “T.N”, the person “U.N”, the person “A.S”, and the person “O.S”, the destinations having been acquired by the destination acquirer 113. In FIG. 11, only some of the destinations of the total of six persons that are the person “N.T”, the person “G.T”, the person “T.N”, the person “U.N”, the person “A.S”, and the person “O.S” are illustrated in the destination image AP. However, the destination image AP may be an image including the destinations of all persons. As illustrated in FIG. 11, when only some of the destinations are included in the destination image AP, it is permissible, for example, to have a configuration in which, after touching the destination image AP, the user Uₖ scrolls the list of plural destinations shown as the destination image AP to make the destinations of all the persons viewable for confirmation by the user. Alternatively, for example, a configuration may be adopted in which, when the user Uₖ taps a destination once to which the message is to be not transmitted in the list of plural destinations shown as the destination image AP, the tapped destination is deleted and a destination that has not been displayed yet is newly displayed.

It is assumed here that the user Uₖ performs a double tap on the person “U.N” as another user U_{M} among the destinations shown in the destination image AP. The receiver 115 receives the double tap by the user Uₖ on the destination representing the person “U.N”.

The communication controller 116 transmits the above message to a destination included in the at least one destination described above in accordance with the user operation by the user Uₖ, that is, the double tap. For example, in the example illustrated in FIG. 11, the communication controller 116 transmits the message to the person “U.N” double-tapped by the user Uₖ in the list of destinations shown in the destination image AP. Specifically, the communication controller 116 outputs the message directed to the person “U.N” to the server 30 via the communication device 13. As will be described later, the server 30 outputs the message directed to the person “U.N” to the terminal apparatus 10-M used by the person “U.N”. As a result, when transmitting a message to another user U_{M} in the virtual space VS, the user Uₖ can transmit the message to the another user U_{M} after easily designating the destination of the message. The user Uₖ may perform a double tap on plural destinations in the list of destinations shown in the destination image AP, which causes the communication controller 116 to transmit a message to the plural destinations via the communication device 13.

### 1-1-4: Configuration of Server

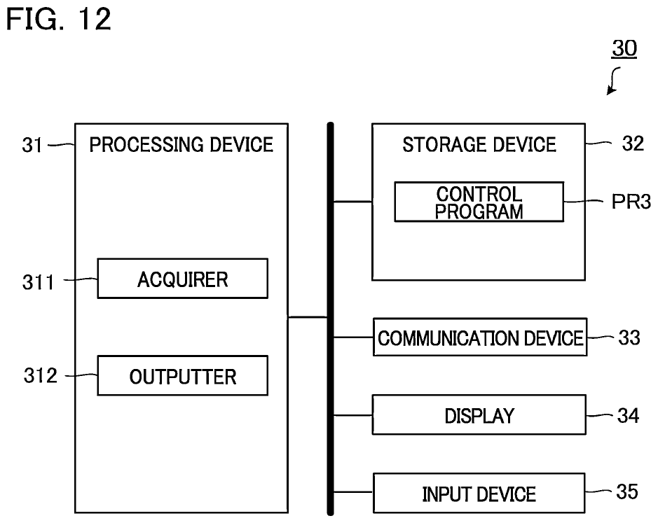

FIG. 12 is a block diagram illustrating a configuration example of the server 30. The server 30 includes a processing device 31, a storage device 32, a communication device 33, a display 34, and an input device 35. These elements included in the server 30 are connected to one another by a single bus or a plurality of buses for communicating information.

The processing device 31 is a processor that controls the entire server 30. For example, the processing device 31 is configured using a single chip or a plurality of chips. For example, the processing device 31 is configured using a central processing unit (CPU) including an interface with peripheral devices, an arithmetic device, a register, and the like. Some or all of functions of the processing device 31 may be realized by hardware such as a DSP, an ASIC, a PLD, and an FPGA. The processing device 31 performs various types of processing in a parallel or serial manner.

The storage device 32 is a recording medium that is readable and writable by the processing device 31. The storage device 32 stores therein programs including a control program PR3 to be executed by the processing device 31. The storage device 32 also stores therein the image information representing images to be displayed on the XR glasses 20.

The communication device 33 is hardware as a transmission and reception device for performing communication with other devices. The communication device 33 is also referred to as, for example, network device, network controller, network card, communication module, and the like. The communication device 33 may include a connector for wired connection and an interface circuit associated with the connector. The communication device 33 may also include a wireless communication interface. Products complying with a wired LAN, IEEE 1394, or USB are cited as the connector for wired connection and the interface circuit. Products complying with a wireless LAN, Bluetooth (Registered Trademark), or the like are cited as the wireless communication interface.

The display 34 is a device that displays images and text information. The display 34 displays various types of images under control of the processing device 31. For example, various types of display panels such as a liquid-crystal display panel and an organic EL display panel are preferably used as the display 34.

The input device 35 is a device that receives operations by an administrator of the information processing system 1. For example, the input device 35 is configured to include a keyboard, a touch pad, a touchscreen, or a pointing device such as a mouse. In a case in which the input device 35 is configured to include a touchscreen, the input device 35 may also function as the display 34.

The processing device 31 reads the control program PR3 from the storage device 32 and executes the program, for example. As a result, the processing device 31 functions as an acquirer 311 and an outputter 312.

The acquirer 311 acquires various types of data from the terminal apparatus 10-K via the communication device 33. As an example, the data includes data that is input to the terminal apparatus 10-K by the user Uₖ wearing the XR glasses 20 on the head and that represents contents of an operation with respect to a virtual object VO.

The acquirer 311 acquires a message from the terminal apparatus 10-K via the communication device 33. For example, as described with reference to FIG. 11, when the terminal apparatus 10-K used by the user Uₖ transmits a message directed to the person “U.N” as another user U_{M}, the acquirer 311 acquires the message directed to the person “U.N” from the terminal apparatus 10-K.

The outputter 312 transmits the message to the terminal apparatus 10-M via the communication device 33. For example, as described with reference to FIG. 11, when the terminal apparatus 10-K used by the user Uₖ transmits the message directed to the person “U.N” as another user U_{M}, the outputter 312 transmits the message directed to the person “U.N”, which is acquired by the acquirer 311, to the terminal apparatus 10-M used by the person “U.N” as described above.

The outputter 312 transmits image information representing an image to be displayed on the XR glasses 20 to the terminal apparatus 10-K via the communication device 33. More specifically, the outputter 312 acquires this image information from the storage device 32. The outputter 312 then transmits the acquired image information to the terminal apparatus 10-K.

### 1-2: Operation of First Embodiment

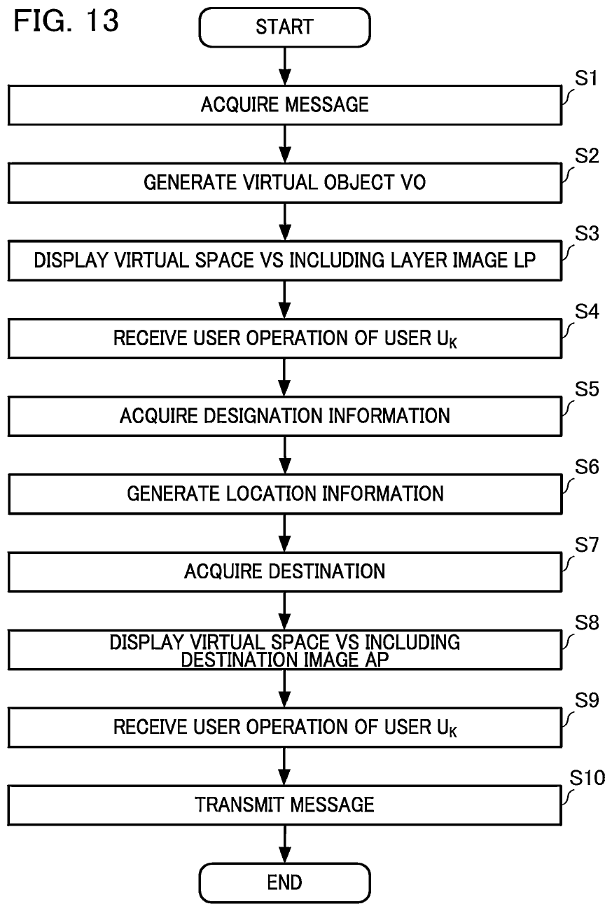

FIG. 13 is a flowchart illustrating an operation of the terminal apparatus 10-K according to the first embodiment. The operations of the terminal apparatus 10-K are described below with reference to FIG. 13.

At Step S1, the processing device 11 functions as the message acquirer 111A. The processing device 11 acquires a message generated by the user Uₖ.

At Step S2, the processing device 11 functions as the object generator 112A. The processing device 11 generates a virtual object VO relating to the message generated at Step S1. The processing device 11 also functions as the display controller 114. The processing device 11 causes the XR glasses 20 as the display device to display a virtual space VS including the generated virtual object VO. Subsequently, the user Uₖ places the virtual object VO in the virtual space VS.

At Step S3, the processing device 11 functions as the display controller 114. The processing device 11 causes the XR glasses 20 as the display device to display a virtual space VS including the virtual object VO generated at Step S2 and a layer image LP indicating a list of layers.

At Step S4, the processing device 11 functions as the receiver 115. The processing device 11 receives a user operation by the user Uₖ made to the layer image LP.

At Step S5, the processing device 11 functions as the information acquirer 111B. The processing device 11 acquires designation information in which a layer corresponding to the area size of a location is designated by the user Uₖ.

At Step S6, the processing device 11 functions as the location information generator 112B. Based on position information representing a position in the virtual space VS at which position the virtual object VO generated at Step S2 has been placed and the designation information acquired at Step S5, the processing device 11 generates location information representing the location in a real space RS corresponding to the position in the virtual space VS at which position the virtual object VO has been placed.

At Step S7, the processing device 11 functions as the destination acquirer 113. The processing device 11 acquires at least one destination corresponding to the location at which the virtual object VO has been placed based on the location information generated at Step S6 and correspondence information representing a correspondence between the location in the real space RS and the at least one destination to which the message is to be transmitted.

At Step S8, the processing device 11 functions as the display controller 114. The processing device 11 causes the XR glasses 20 as the display device to display a virtual space VS including the virtual object VO generated at Step S2 and a destination image AP indicative of the at least one destination extracted at Step S7.

At Step S9, the processing device 11 functions as the receiver 115. The processing device 11 receives a user operation by the user Uₖ made to the destination image AP.

At Step S10, the processing device 11 functions as the communication controller 116. The processing device 11 transmits a message to a destination included in the at least one destination extracted at Step S7 in accordance with the user operation by the user Uₖ received at Step S9. Subsequently, the processing device 11 ends the processing illustrated in FIG. 13.

### 1-3: Effects Achieved by First Embodiment

According to the above descriptions, the terminal apparatus 10-K as a display control apparatus includes the destination acquirer 113 and the display controller 114. The destination acquirer 113 acquires at least one destination to which a message to be transmitted, the destination corresponding to the location in a real space RS that corresponds to the position in a virtual space VS at which position a virtual object VO relating to the message has been placed, based on correspondence information representing a correspondence between location information representing the location in the real space RS and at least one destination to which the message is to be transmitted, and the location in the real space RS. The display controller 114 causes the XR glasses 20 as a display device to display a virtual space VS including the virtual object VO and a destination image AP indicative of at least one destination.

Since the terminal apparatus 10-K has the configuration described above, when the user Uₖ transmits a message to another user U_{M} in the virtual space VS, the user Uₖ can easily designate and confirm the destination. In particular, upon the user Uₖ having placed a virtual object VO relating to the message in the virtual space VS, the terminal apparatus 10-K causes the XR glasses 20 to display a destination image AP indicative of at least one destination, which corresponds to the location in a real space RS corresponding to the position at which the virtual object VO has been placed in the virtual space VS. As a result, the user Uₖ can easily recognize at least one destination that is highly relevant to the location in the real space RS corresponding to the position in the virtual space VS at which position the virtual object VO has been placed.

According to the above descriptions, the location information has an information structure in which locations are classified into layers according to the area sizes. The terminal apparatus 10-K further includes the information acquirer 111B and the location information generator 112B. The information acquirer 111B acquires designation information in which a layer corresponding to the area size of a location is designated by the user Uₖ. On the basis of position information representing the position in the virtual space VS at which position the virtual object VO has been placed and the designation information described above, the location information generator 112B generates the location information described above.

Since the terminal apparatus 10-K has the configuration described above, the user Uₖ can designate the unit of scale to be used as the unit of the location in the real space RS for recognizing at least one destination that is highly relevant to the location in the real space RS corresponding to the position in the virtual space VS at which position the virtual object VO has been placed. Specifically, the user Uₖ can designate, for example, a unit of town, a unit of building, a unit of floor, a unit of house, or a unit of room as the unit of location in the real space RS.

According to the above descriptions, the information acquirer 111B acquires designation information after the virtual object VO has been placed in the virtual space VS.

Since the terminal apparatus 10-K has the configuration described above, the user Uₖ can designate, after placing the virtual object VO in the virtual space VS, what extent of scale unit is to be used as the unit of location in the real space RS including the position at which the virtual object VO has been placed.

According to the above descriptions, the terminal apparatus 10-K further includes the receiver 115 and the communication controller 116. The receiver 115 receives a user operation made to the destination image AP. The communication controller 116 transmits the message to a destination included in the at least one destination described above in accordance with the user operation.

Since the terminal apparatus 10-K includes the configuration described above, when transmitting a message to another user U_{M} in the virtual space VS, the user Uₖ can transmit the message to the user U_{M} after easily designating the destination of the message. In particular, the user Uₖ can transmit a message to a selected destination by merely performing a user operation of selecting at least one destination from a list of destinations included in the destination image AP.

### 2: Second Embodiment

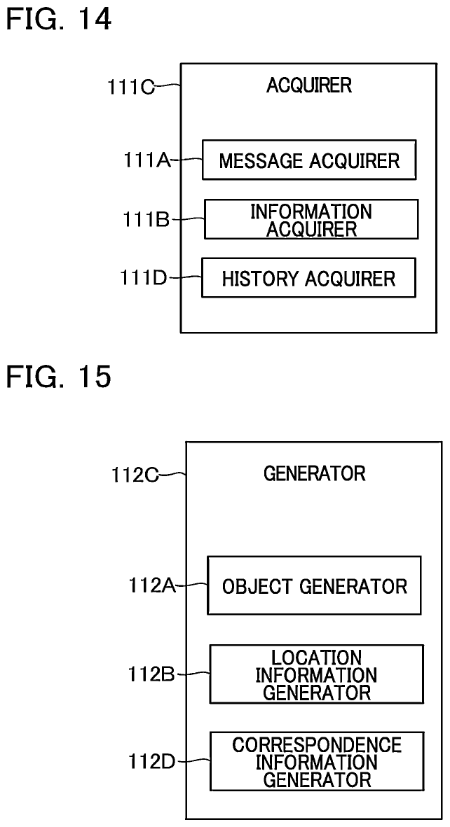

A configuration of an information processing system 1A including a terminal apparatus 10A-K as a display control apparatus according to a second embodiment of the present invention is described below with reference to FIGS. 14 and 15. In the following descriptions, in order to simplify explanations, similar reference signs are used for constituent elements that are the same as those of the information processing system 1 according to the first embodiment among the constituent elements included in the information processing system 1A according to the second embodiment, and descriptions thereof may be omitted.

### 2-1: Configuration of Second Embodiment

### 2-1-1: Overall Configuration

The information processing system 1A according to the second embodiment of the present invention is different from the information processing system 1 according to the first embodiment in including the terminal apparatus 10A-K instead of the terminal apparatus 10-K. The overall configuration of the information processing system 1A is the same as that of the information processing system 1 according to the first embodiment illustrated in FIG. 1 other than the above element. Accordingly, illustrations and descriptions thereof are omitted.

### 2-1-2: Configuration of Terminal Apparatus

Unlike the terminal apparatus 10-K, the terminal apparatus 10A-K includes a processing device 11A and a storage device 12A instead of the processing device 11 and the storage device 12. Unlike the storage device 12, the storage device 12A stores therein a control program PR1A instead of the control program PR1. The processing device 11A includes an acquirer 111C and a generator 112C instead of the acquirer 111 and the generator 112 both included in the processing device 11. Apart from these features, the configuration of the terminal apparatus 10A-K is the same as the overall configuration of the terminal apparatus 10-K according to the first embodiment illustrated in FIG. 5. Accordingly, illustrations and descriptions of thereof are omitted.

FIG. 14 is a functional block diagram of the acquirer 111C. The acquirer 111C includes a history acquirer 111D in addition to the constituent elements included in the acquirer 111.

The history acquirer 111D acquires a history of users associated with a location in the real space RS. As an example, with reference to FIG. 6, the history acquirer 111D acquires, as a history of users of “living room” in “T's residence” on “7F”, which is the location in the real space RS, a history indicating that the person “N.T” and the person “G.T” have used the location. For example, the history acquirer 111D may acquire a history of users associated with the location in the real space RS input by the user Uₖ using the input device 15. Alternatively, the history acquirer 111D may acquire a history of users associated with the location of the real space RS from an external device via the communication device 13.

FIG. 15 is a functional block diagram of the generator 112C. The generator 112C includes a correspondence information generator 112D in addition to the constituent elements included in the generator 112.

The correspondence information generator 112D generates correspondence information on the basis of the history of users associated with the location in the real space RS acquired by the history acquirer 111D. As an example, with reference to FIG. 6, the correspondence information generator 112D generates, based on the history of users of “living room” in “T's residence” on “7F” acquired by the history acquirer 111D, correspondence information representing that this “living room” corresponds to the person “N.T” and the person “G.T”. As a result, the user Uₖ can easily establish the correspondence database CD to be stored in the storage device 12A of the terminal apparatus 10A-K. The user Uₖ can also generate correspondence information to be stored in the correspondence database CD according to an actual user of the location in the real space RS.

### 2-2: Operation of Second Embodiment

An operation of the terminal apparatus 10A-K according to the second embodiment is basically the same as that of the terminal apparatus 10-K illustrated in FIG. 13, illustrations and descriptions thereof are omitted. In the operation of the terminal apparatus 10A-K, the correspondence information used at Step S7 is generated by the correspondence information generator 112D during the operations of the terminal apparatus 10-K.

### 2-3: Effects Achieved by Second Embodiment

According to the above descriptions, the terminal apparatus 10A-K as a display control apparatus further includes the history acquirer 111D and the correspondence information generator 112D in addition the constituent elements included in the terminal apparatus 10-K. The history acquirer 111D acquires a history of users associated with the location in the real space RS. The correspondence information generator 112D generates correspondence information on the basis of the history of users.

Since the terminal apparatus 10A-K includes the configuration described above, the user Uₖ can easily establish the correspondence database CD to be stored in the storage device 12A of the terminal apparatus 10A-K. The user Uₖ can also generate the correspondence information to be stored in the correspondence database CD according to an actual user of the location in the real space RS.

### 3: Modifications

The present disclosure is not limited to the embodiments exemplified above. Specific modes of modifications are illustrated below. Two or more modes freely selected from the following examples may be combined with one another.

### 3-1: First Modification

In the terminal apparatus 10-K according to the first embodiment, the correspondence database CD stored in the storage device 12 stores therein a correspondence between (i) the location in a real space RS represented by location information with an information structure in which locations are classified into layers according to the area sizes, and (ii) at least one destination. However, this location information does not need to have the information structure in which locations are classified into layers according to area sizes. That is, the location information may have an information structure constituted of only one layer. In this case, the location information generator 112B does not need to use any designation information. Therefore, the terminal apparatus 10-K does not need to include the information acquirer 111B as its essential constituent element. The same holds for the terminal apparatus 10A-K according to the second embodiment.

### 3-2: Second Modification

In the terminal apparatus 10A-K according to the second embodiment, after the history acquirer 111D has acquired a history of users of the real space RS, the correspondence information generator 112D generates correspondence information on the basis of the history of users of the real space RS. Subsequently, the destination acquirer 113 acquires at least one destination corresponding to the location where the virtual object VO has been placed, on the basis of the location information and the correspondence information. The display controller 114 displays in a virtual space VS a destination image AP indicative of at least one destination acquired by the destination acquirer 113.

However, the destination acquirer 113 does not need to acquire the at least one destination on the basis of the location information and the correspondence information. For example, the destination acquirer 113 may acquire at least one destination corresponding to the location where the virtual object VO has been placed, on the basis of the location information and the history information itself, which represents a history of users associated with the real space RS and is acquired by the history acquirer 111D. Subsequently, the display controller 114 may display a destination image AP indicative of at least one destination acquired by the destination acquirer 113 and linked to the history information itself in a virtual space VS. In other words, the display controller 114 may display the history itself of users of the location where the virtual object VO has been placed as a destination image AP in a virtual space VS.

### 3-3: Third Modification

In the terminal apparatus 10-K according to the first embodiment, the message acquirer 111A acquires a message generated by the user Uₖ. Subsequently, the object generator 112A generates a virtual object VO associated with the message acquired by the message acquirer 111A. That is, in the terminal apparatus 10-K, after the user Uₖ has generated a message, a virtual object VO is generated on the basis of this message. However, the user Uₖ may first create a virtual object VO using the input device 15 and then creates a message linked to this virtual object VO. The same holds for the terminal apparatus 10A-K according to the second embodiment.

### 3-4: Fourth Modification

In the terminal apparatus 10-K according to the first embodiment, after the user Uₖ has placed a virtual object VO in a virtual space VS, the information acquirer 111B acquires designation information in which the layer is designated by the user Uₖ. However, the user Uₖ may place a virtual object VO after the user Uₖ designates a layer and the information acquirer 111B acquires the designation information. More specifically, for example, in a state in which the user Uₖ holds a virtual object VO, the user Uₖ may designate a layer corresponding to the area size of the location in the real space RS corresponding to the position of the virtual object VO in the virtual space VS and then place the virtual object VO therein. Furthermore, the user Uₖ may place a virtual object VO after designating the destination of a message by operating a destination image AP displayed based on a designated layer. The same holds for the terminal apparatus 10A-K according to the second embodiment.

### 3-5: Fifth Modification

In the information processing system 1 according to the first embodiment, the terminal apparatus 10-K includes the acquirer 111, the generator 112, the destination acquirer 113, the display controller 114, and the correspondence database CD as main constituent elements. However, instead of the terminal apparatus 10-K, the server 30 may include substantially the same constituent elements as those of the terminal apparatus 10-K. The same holds for other constituent elements. The same holds for the information processing system 1A according to the second embodiment.

### 3-6: Sixth Modification

In the information processing system 1 according to the first embodiment, the terminal apparatus 10-K and the XR glasses 20 are realized as separate elements. However, the method for realizing the terminal apparatus 10-K and the XR glasses 20 in the embodiments of the present invention is not limited thereto. For example, the XR glasses 20 may have the same functions as those of the terminal apparatus 10-K. In other words, the terminal apparatus 10-K and the XR glasses 20 may be realized in the same casing. The same holds for the information processing system 1A according to the second embodiment.

### 3-7: Seventh Modification

The information processing system 1 according to the first embodiment includes the XR glasses 20. In the above descriptions, the XR glasses 20 are, for example, MR glasses. However, the XR glasses 20 may be any one of VR glasses based on the VR technology, an HMD (Head Mounted Display) based on the VR technology, AR glasses based on the AR technology, an HMD based on the AR technology, and an HMD based on the MR technology. Alternatively, the information processing system 1 may include any one of a normal smartphone and a normal tablet both including an image capture device instead of the XR glasses 20. Such VR glasses, AR glasses, HMDs, smartphone, and tablet are examples of the display device. The same holds for the information processing system 1A according to the second embodiment.

### 4: Other Matters

(1) Although a ROM, a RAM, and the like are exemplified as the storage devices 12 and 12A, the storage device 22, and the storage device 32 in the above embodiments, these devices are appropriate forms of storage media such as a flexible disk, a magneto-optical disk (for example, a compact disk, a digital versatile disk, or a Blu-ray (Registered Trademark) disk), a smart card, a flash memory device (for example, a card, a stick, or a key drive), a CD-ROM (Compact Disc-ROM), a register, a removable disk, a hard disk, a floppy (Registered Trademark) disk, a magnetic strip, a database, and a server. Programs may be transmitted from a network via a telecommunication line. Programs may be also transmitted from the communication network NET via a telecommunication line.

(2) In the above embodiments, information, signals, and the like described in this disclosure may also be represented using any of a variety of different technologies. For example, data, instructions, commands, information, signals, bits, symbols, chips, and the like mentioned throughout the entirety of the above descriptions may be referenced by voltages, currents, electromagnetic waves, magnetic fields or particles, optical fields or photons, or any combination thereof.

(3) In the above embodiments, input and output information and the like may be stored in a specific location (for example, a memory) or may be managed using a management table. Information to be input and output and the like may be overwritten, updated, or added. Output information and the like may be deleted. Input information and the like may be transmitted to another device.

(4) In the above embodiments, determination may be made based on a value (0 or 1) expressed by using one bit, based on a truth value (Boolean: true or false), or based on comparison of numerical values (for example, comparison with a predetermined value).

(5) The order of the processing procedures, sequences, flowcharts, and the like exemplified in the above embodiments may be rearranged as long as there is no conflict. For example, the method described in the present disclosure presents elements of various steps in an exemplary order and is not limited to the specific order presented.

(6) Each of the functions exemplified in FIG. 1 to FIG. 15 is realized by an optional combination of at least one of hardware and software. The method for realizing each functional block is not particularly limited to any specific method. That is, each functional block may be realized by using one device combined physically or logically or realized by directly or indirectly connecting (for example, using wired or wireless communication) two or more devices physically or logically separated from each other and using these plural devices. Each functional block may be realized by combining software with the one device or the plural devices mentioned above.

(7) Regardless of whether the programs exemplified in the above embodiments are referred to as software, firmware, middleware, microcode, or hardware description language, or some other name, the programs should be interpreted broadly to mean instructions, instruction set, code, code segment, program code, program, subprogram, software module, application, software application, software package, routine, subroutine, object, executable file, execution thread, procedure, function, and the like.

Software, instruction, information, and the like may be transmitted and received via a transmission medium. For example, when software is transmitted from a website, a server, or another remote source using at least one of a wired technology (such as coaxial cable, fiber optic cable, twisted pair, and Digital Subscriber Line (DSL)) and a wireless technology (such as infrared light or microwave), at least one of the wired and wireless technologies is included in the definition of the transmission medium.

(8) In each of the above embodiments, the terms “system” and “network” are used interchangeably.

(9) Information, parameters, and the like described in the present disclosure may be expressed using absolute values, relative values from predetermined values, or other information corresponding thereto.

(10) In the above embodiments, a case in which the terminal apparatuses 10-1 to 10-J and 10A-K and the server 30 are mobile stations (MS) is included. There are cases in which, by those skilled in the art, the mobile stations are referred to as subscriber stations, mobile units, subscriber units, wireless units, remote units, mobile devices, wireless devices, wireless communication devices, remote devices, mobile subscriber stations, access terminals, mobile terminals, wireless terminals, remote terminals, handsets, user agents, mobile clients, clients, or some other appropriate terms. In the present disclosure, terms such as “mobile station”, “user terminal”, “user equipment (UE)”, and “terminal” may be used interchangeably.

(11) In the above embodiments, the terms “connected”, “coupled”, or any variations thereof mean any direct or indirect connection or coupling between two or more elements and one or more intermediate elements may be present between two elements that are “connected” or “coupled” to each other. The coupling or connection between elements may be physical coupling or connection, logical coupling or connection, or a combination thereof. For example, “connection” may be rephrased as “access”. When such terms are used in the present disclosure, two elements are regarded to be “connected” or “coupled” to each other by using at least one of one or more wires, cables, printed electrical connections, and as some non-limiting and non-exhaustive examples, by using electromagnetic energy having wavelengths in radio-frequency regions, microwave regions, and light (both visible and invisible) regions, and the like.

(12) In the above embodiments, the description “based on” does not mean “based only on” unless explicitly stated otherwise. In other words, the description “based on” means both “based only on” and “based at least on”.

(13) The term “determining” or “deciding” used in the present disclosure may encompass a wide variety of actions. “Determining” or “deciding” may include regarding some actions such as judging, calculating, computing, processing, deriving, investigating, looking up, search, inquiry (for example, searching in a table, database, or other data structures), and ascertaining, as it has been “determined” or “decided”. “Determining” or “deciding” may also include regarding some actions such as receiving (for example, receiving information), transmitting (for example, transmitting information), input, output, and accessing (for example, accessing data in a memory), as it has been “determined” or “decided”. “Determining” or “deciding” may also include regarding some actions such as resolving, selecting, choosing, establishing, and comparing, as it has been “determined” or “decided”. That is, “determining” or “deciding” may include regarding some actions have been “determined” or “decided”. In addition, “determining (deciding)” may be rephrased as “assuming”, “expecting”, “considering”, and the like.

(14) In the above embodiments, when terms “include”, “including”, and variations thereof are used, these terms are intended to be inclusive in a manner similar to the term “comprising”. In addition, the term “or” used in the present disclosure is intended not to be an exclusive OR.

(15) In the present disclosure, for example, in translation, if articles such as “a”, “an”, and “the” in English are added, this disclosure may include a case in which a noun following these articles is plural.

(16) In the present disclosure, the term “A and B are different” may mean “A and B are different from each other”. Note that the term may also mean “A and B are each different from C”. Terms such as “leave”, “coupled”, or the like may also be interpreted in the same manner as “different”.

(17) Each aspect or embodiment described in the present disclosure may be used separately or in combination, or may be used as they are switched in accordance with execution. In addition, notification of predetermined information (for example, notification of “being X”) is not limited to being performed explicitly, and it may be performed implicitly (for example, without notifying the predetermined information).

While the present disclosure has been described above in detail, it is obvious to those skilled in the art that the present disclosure is not limited to the embodiments described in the present disclosure. The present disclosure can be implemented as modifications and variations without departing from the spirit and scope of the present disclosure as defined by the descriptions in the claims. Accordingly, the descriptions in the present disclosure are for illustrative purposes and are not of any restrictive significance to the present disclosure.

### DESCRIPTION OF REFERENCE SIGNS

1, 1A . . . information processing system, 10-1, 10-2, 10-K, 10-J, 10A-K . . . terminal apparatus, 11, 11A . . . processing device, 12, 12A . . . storage device, 13 . . . communication device, 14 . . . display, 15 . . . input device, 16 . . . inertia sensor, 20 . . . . XR glasses, 21 . . . processing device, 22 . . . storage device, 23 . . . line-of-sight detecting device, 24 . . . . GPS device, 25 . . . motion detecting device, 26 . . . image capture device, 27 . . . communication device, 28 . . . display, 30 . . . server, 31 . . . processing device, 32 . . . storage device, 33 . . . communication device, 34 . . . display, 35 . . . input device, 41L, 41R . . . lens, 91, 92 . . . temple, 93 . . . bridge, 94, 95 . . . frame, 111 . . . acquirer, 111A . . . message acquirer, 111B . . . information acquirer, 111C . . . acquirer, 111D . . . history acquirer, 112 . . . generator, 112A . . . object creator, 112B . . . location information generator, 112C . . . creator, 112D . . . correspondence information generator, 113 . . . destination acquirer, 114 . . . display controller, 115 . . . receiver, 116 . . . communication controller, 311 . . . acquirer, 312 . . . outputter, PR1 to PR3 . . . control program, U_{K}, U_{M} . . . user, VO . . . virtual object

1. A display control apparatus comprising:
a destination acquirer configured to acquire at least one destination to which a message is to be transmitted, the at least one destination corresponding to a location in a real space, with the location corresponding to a position in a virtual space at which position a virtual object relating to the message has been placed, based on
location information indicative of the location in the real space, and
correspondence information indicative of a correspondence between the location in the real space and the at least one destination, to which the message is to be transmitted; and
a display controller configured to cause a display device to display the virtual space including both the virtual object and a destination image representative of the at least one destination.

2. The display control apparatus according to claim 1, wherein
the location information has an information structure in which locations are classified into a plurality of layers according to area sizes, and
the display control apparatus further comprises:
an information acquirer configured to acquire designation information in which a layer corresponding to an area size of the location is designated by a user; and
a location information generator configured to generate the location information based on
position information representative of the position in the virtual space, at which position the virtual object has been placed, and
the designation information.

3. The display control apparatus according to claim 2, wherein the information acquirer is configured to acquire the designation information after the virtual object has been placed in the virtual space.

4. The display control apparatus according to claim 1, further comprising:
a history acquirer configured to acquire a history of users associated with the location in the real space; and
a correspondence information generator configured to generate the correspondence information based on the history of users.

5. The display control apparatus according to claim 1, further comprising:
a receiver configured to receive a user operation made to the destination image; and
a communication controller configured to transmit the message to a destination included in the at least one destination based on the user operation.

6. The display control apparatus according to claim 2, further comprising:
a history acquirer configured to acquire a history of users associated with the location in the real space; and
a correspondence information generator configured to generate the correspondence information based on the history of users.

7. The display control apparatus according to claim 3, further comprising:
a history acquirer configured to acquire a history of users associated with the location in the real space; and
a correspondence information generator configured to generate the correspondence information based on the history of users.
